(19) United States
(12) Patent Application Publication
(10) Pub. No.: US 2003/0236860 A1
(43) Pub. Date: Dec. 25, 2003

(54) Link-layer triggers protocol

(76) Inventor: Alper E. Yegin, Foster City, CA (US)

Correspondence Address: BRINKS HOFER GILSON & LIONE, ONE INDIANA SQUARE, SUITE 1600, INDIANAPOLIS, IN, 46204-2033, US

(21) Appl. No.: 10/272,092

(22) Filed: Oct. 16, 2002

Related U.S. Application Data
(60) Provisional application No. 60/389,868, filed on Jun. 19, 2002.

(51) Int. Cl. G06F 15/16

(52) U.S. Cl. 709/218; 709/227

(57) ABSTRACT

A link-layer trigger protocol for data communication between a client and a wireless access device. A client is connected to a wireless access device, where the client and the wireless access device are operable to communicate with one another using a link-layer trigger datagram. The link-layer trigger datagram includes an IP header, a UDP header and a link-layer trigger header.

### This application claims the benefit of U.S. Provisional Application Serial No. 60/389,868 filed on Jun. 19, 2002.

### FIELD OF THE INVENTION

The present invention relates generally to link-layer triggers and more particularly, to a link-layer trigger protocol for use in a wireless access network.

### BACKGROUND OF THE INVENTION

Wireless and mobile hosts are subject to changing their point of attachment from one access network to another, which is typically referred to as a handover. Handovers involve a change in link-layer connectivity and sometimes involve a change in network-layer connectivity as well. A client must identify a new attachment point, disassociate itself from the current attachment point, and associate with the new attachment point. After this process, depending on whether the new attachment point is still part of the same network subnet as the previous link, the client may also need to take actions to re-establish network-layer connectivity.

The link-layer of the client and the access node on the access network have knowledge and control of link-layer events. These events may include anticipation and execution of a client associating/disassociating with the link. While information on these events is already available to the link-layer of involved parties, they are transparent to the network-layers. In some instances, availability of this information at the network-layer is required for re-establishing network-layer connectivity. Certain protocols rely on this information to function and others perform better when this information is available. Link-layer events are communicated to the network-layer in the form of a link-layer (L2) trigger. Various types of information need to be carried in L2 triggers.

Link-layer and network-layer of a client are co-located on the same IP node in a standard network stack implementation. Therefore L2 events take place on the same node and network-layer can be notified via internal mechanisms. An interface between two modules running on the same IP node should be sufficient and is needed.

A problem arises when wireless bridges are used in connecting hosts to networks. Wireless bridges are connected to each other via a wireless link which is defined by its two end points. As an example, a laptop might be using a portable or mobile phone to associate with a wireless link. Similarly, an access router might be using a base station to provide service over the wireless link. In this case, only the bridges can know when a client is associated or disassociated with the link. Neither the client nor the access router can use an internal method to get informed about the L2 events associated with the wireless link. As such, a new transport is needed to convey L2 trigger information between two IP nodes (i.e., from bridges to the interested parties).

### SUMMARY OF THE INVENTION

An embodiment of the present invention discloses a link-layer (“L2”) trigger protocol for data communication between at least one client and a wireless access device or point. In this embodiment, the client is connected to the wireless access device or point. The client and the wireless access device or point is operable to communicate with one another using an L2 trigger datagram. The L2 trigger datagram includes an IP header, a UDP header and a L2 trigger header. The L2 trigger header is used to transmit trigger events, as well as other messages, to the client or the wireless access device or point.

The L2 trigger header includes an L2 message type field for identifying a respective type of L2 message that is being communicated and an L2 trigger data field for transmitting a data message. The type of L2 message may be selected from a group of L2 messages including a hello message, a registration message, a trigger message, and a query message.

The hello message is preferentially used by the client to discover wireless access devices or points on the network. The hello message includes a client indicator that is set to a first predetermined value when the hello message is sent by the client and is set to a second predetermined value when the hello message is not sent by the client. The registration message is used to register the client with wireless access devices or points. The registration message includes a request indicator and a lifetime data field. The request indicator is set to a first predetermined value when the registration message is a registration request message and is set to a second predetermined value when the registration message is a registration acknowledgement message. The lifetime data field represents an amount of time that the client has remaining to be registered with the wireless access device or point.

The trigger message includes an acknowledge request indicator, an identification number field, and a trigger data field. The acknowledge request indicator is set to a first predetermined value if the client must send back an acknowledgement to the wireless access device or point. The identification number field is used for matching the trigger messages with a trigger acknowledgment. The trigger data field includes a stream of L2 event data. The stream of L2 event data includes an event type indication, a data length indication and a trigger event data field.

The event type indication is used to identify an L2 trigger event that may be selected from a group of L2 trigger events including a link up event, a link down event, a source pre-trigger event, a target pre-trigger event, and a mobile pre-trigger event. The data length indication is used to identify a size associated with the trigger event data field. The trigger event data field identifies a respective trigger event and contains data relevant to the specifics of the trigger event.

Another embodiment of the present invention discloses a method for providing trigger notification to a client using a wireless access device to establish a wireless link with an access point. In this embodiment, an address of the wireless access device connected with the client is identified. Once identified, the client registers with the wireless access device. An L2 trigger datagram is generated with the wireless access device when the wireless access device experiences an L2 trigger event. After generated, the L2 trigger datagram is sent to the client.

The L2 trigger datagram includes an L2 trigger field and an L2 data field. The address of the wireless access device may be identified by a manual configuration or through the assistance of a dynamic discovery application. The client may identify the wireless access device by sending a multicast hello message to a predetermined IP address and the wireless access devices generates a unicast hello message that is sent back to the client in response to the multicast hello message. The client registers with the wireless access device by sending a registration message to the wireless access device and the wireless access device acknowledges registration by generating a registration acknowledgement message that is sent to the client.

The L2 trigger event may be selected from a group of events including a link down event, a link up event, a source pre-trigger event, a target pre-trigger event, and a mobile pre-trigger event. A pre-trigger cancel message may also be sent to the client to indicate that conditions leading to an earlier sent L2 datagram should be disregarded by the client.

Further objects and advantages of the present invention will be apparent from the following description, reference being made to the accompanying drawings wherein preferred embodiments of the invention are clearly illustrated.

### BRIEF DESCRIPTION OF THE FIGURES

FIG. 1 is a block diagram of a wireless access network

FIG. 2 is a more detailed diagram of an illustrative wireless access network.

FIG. 3 is an illustration of an L2 trigger protocol.

FIG. 4 is an illustration of an L2 trigger header.

FIG. 5 is an illustration of an L2 trigger for a hello message.

FIG. 6 s an illustration of an L2 trigger header for a registration message.

FIG. 7 is an illustration of an L2 trigger header for a trigger message.

FIG. 8 is an illustration of a trigger data field of the trigger message.

FIG. 9 is an illustration of an L2 trigger header for a query message.

### DETAILED DESCRIPTION OF THE PRESENTLY PREFERRED EMBODIMENTS OF THE INVENTION

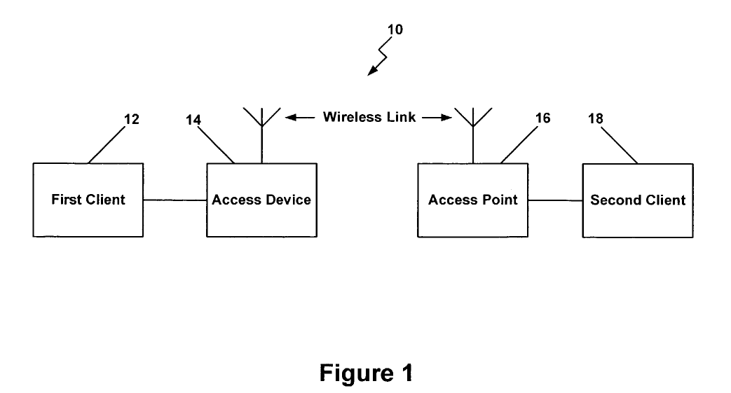

Referring to FIG. 1, the present invention discloses a data link-layer or layer two (“L2”) trigger protocol for use in a wireless access network 10. The terms link-layer or L2 as used herein are used to refer to Layer 2 of the Open Systems Interconnect (“OSI”) model. The wireless access network 10 includes a client 12 that is connected to a wireless access device 14. The wireless access device 14 is connected to a wireless access point 16. The wireless access point 16 is connected to a second client 18. The wireless access device 14 and the wireless access point 16 establish a wireless link between the client 12 and the second client 18.

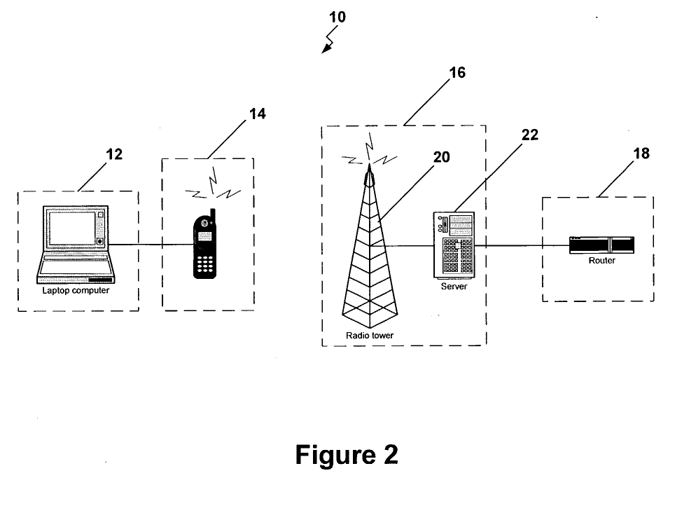

As illustrated in FIG. 2, the client 12 may comprise a laptop computer, a computing device or a portable computing device. The wireless access device 14 may comprise a wireless remote terminal or phone, a PCMCIA wireless access device or any other type of wireless access device that is capable of being connected to a computing device. The wireless access point 16 may include a base station 20 that is connected to a server 22. The server 22 is connected to the second client 18, which is illustrated in FIG. 2 as a router. The wireless link that is established between the client 12 and the second client 18 allows the client 12 to send and receive data over a network connection that is created by the wireless link. For the purpose of the discussion below, the wireless access device 14 and the wireless access point 16 are referred to as servers 14, 16 unless otherwise specified.

A preferred embodiment of the present invention discloses a system and method for using an L2 trigger protocol that is capable of, amongst other things, notifying the client 12 of an L2 trigger. In a preferred embodiment of the present invention, the client 12 identifies at least one server 14 that is connected with the client 12. This can happen either by manual configuration or dynamic discovery. The client 12 can discover servers 14on the same subnet by multicasting a hello message to a well-known IP address. The servers 14 respond to this message by generating a unicast hello message that is sent back to the client 12. The client 12 may periodically send these multicast hello messages to keep track of active servers 14, The client 12 can also send a unicast hello message to learn if a respective server 14 is still alive. When a server 14, 16 starts, it preferentially multicasts a hello message to announce its service. In the preferred embodiment, the client 12 preferentially does not respond to unsolicited hello messages.

Once the client 12 identifies a server 14 to receive L2 triggers from, it must register with the server 14. The client 12 sends a registration message to the server 14 and the server 14 sends back a registration acknowledgement message to the client 12. Each registration preferentially has a finite lifetime and must be renewed before expiration. After registration takes place, the server 14 will notify the client 12 about L2 events that take place on the server 14. The client 12 can de-register from the server 14 at any time by sending a registration message with a lifetime value of zero and the server 14 preferentially sends back a registration acknowledgement message with a lifetime value of zero.

When an L2 event takes place on a respective server 14, 16, the server 14, 16 sends a trigger message to every one of the clients 12, 18 that are registered with the server 14, 16. The server 14, 16 may choose to combine more than one L2 trigger in a single message, which is subject to local policy. The server 14, 16 may also request an acknowledgement from the clients 12, 18 and the clients 12, 18 must send back a trigger acknowledgement to the server 14, 16 in this case. In the preferred embodiment, L2 trigger events include a link down event, a link up event, a source pre-trigger event, a target pre-trigger event, and a mobile pre-trigger event. Additionally, the server 14, 16 may send a pre-trigger cancel in the trigger message to indicate conditions leading to an earlier sent pre-trigger has changed and that pre-trigger should be disregarded.

A link up event generally occurs at a point in time when the L2 link comes up or is made available to the client 12. A link down event generally occurs at a point in time in which the L2 link goes down between the client 12 and a respective access node or point 16. A source pre-trigger event occurs sufficiently before an L2 handover starts and is received by the current access point 16 of of the client 12. A target pre-trigger event occurs sufficiently before a L2 handover starts and is received by the target access point 16. A mobile trigger event occurs sufficiently before a L2 handover starts and is received by the client 12.

In addition to getting notified of the L2 events, the client 12 can query a respective server 14, 16 for the status of a specific link. The client 12 can query its respective wireless access device 14 to learn if it is still associated with a specific access point 16. Similarly, an access router or second client 18 can query the access point 16 to learn if a specific client or server 14, 16 is still associated with it. The clients 12, 18 send a query request message to the server 14, 16 and the server 14, 16 replies with a query response.

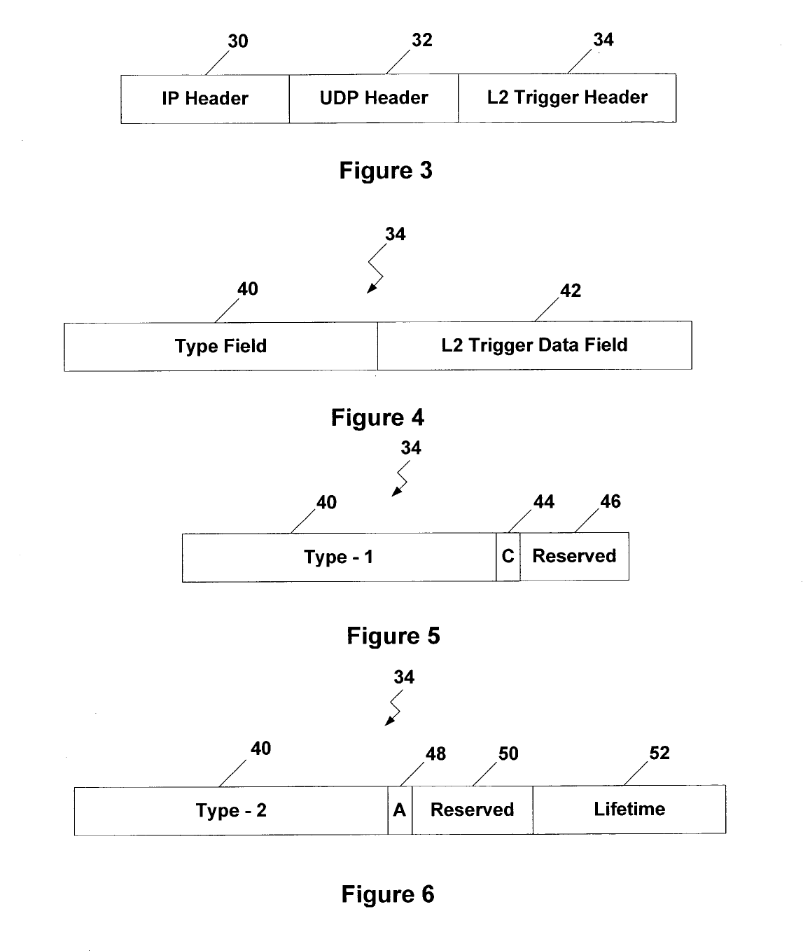

The preferred L2 trigger protocol is a user datagram protocol (“UDP”) based client-server protocol. Both the client 12 and the server 14, 16 join a well-known multicast group and listen on a well-known port. Referring to FIG. 3, the preferred L2 trigger protocol includes an IP field or header 30, a UDP field or header 32 and an L2 trigger field or header 34. Although not specifically illustrated, the IP header 30 includes a source address field, a destination address field and a time-to-live field. The source address field is typically the interface address from which the message is sent. The destination address field is typically the interface address to which the message is sent, which may be determined when the hello message is multicast. The time-to-live field indicates how long the datagram will remain alive in the network (always typically set to 255 when sent, the receiver must verify this value to limit use of this protocol to nodes on the same IP link). If the datagram is in the network longer than the time to live, then the datagram is destroyed.

The UDP header 32 includes a source port field (variable, when not sent as a response, to be determined when sent as a response to an incoming message) and a destination port field (copied from the incoming message's source port when sent as a response, to be determined otherwise). As known in the art, UDP is a protocol within the TCP/IP protocol suite that is used in place of TCP when a reliable delivery is not required. For example, UDP is used for real-time audio and video traffic where lost packets are simply ignored, because there is no time to retransmit. If UDP is used and a reliable delivery is required, packet sequence checking and error notification should be written into the applications.

Referring to FIG. 4, the UDP header 32 is followed by the L2 trigger header 34. The L2 trigger header 34 includes a type field 40 and an L2 trigger data field 42. In the preferred embodiment, the type field 40 is used to indicate the type of message that is being sent to either the clients 12, 18 or the server 14, 16. In the present preferred embodiment the type of messages may be selected from a group of messages that include a hello message, a registration message, a trigger message and a query message. As set forth below, the L2 trigger data field 42 contains data that is specific to each type of message that is being sent to either the clients 12, 18 or the servers 14, 16. Each of the messages and the type of data that might be sent with each message is set forth in detailed below.

As set forth above, the L2 trigger header 34 may include a type field 40 that may be used to indicate the transmission of a hello message. This message is used by clients 12, 18 to discover servers 14, 16 and by servers 14, 16 to announce their availability to clients 12, 18. Referring to FIG. 5, in the preferred embodiment of the present invention the L2 trigger header 34 includes the following protocol fields for a hello message. The type field 40 may be set to a predetermined value to indicate that the message is a hello message. In the preferred embodiment, the type field 40 is set to a binary value of one to signal that the message is a hello message. A client indicator 44 is included in the L2 trigger data field 42. In the preferred embodiment, the client indicator 44 is set to a binary value of one when the hello message is sent by a client 12, 18 and set to a binary value of zero otherwise. A reserved field 46 is also included in the L2 trigger data field 42 that may be used for application specific data.

Referring to FIG. 6, the type field 40 may also be used to indicate that the message being sent is a registration message. Clients 12, 18 use this message for registering with the servers 14, 16. Once the clients 12, 18 are registered with the servers 14, 16, the servers 14, 16 will start delivering L2 triggers to the registered clients 12, 18. The same message is preferentially used for both registration requests and registration acknowledgements.

The L2 trigger header 34 includes the following protocol fields for a registration message. The type field 40 is set to a binary value of two to indicate that the message is a registration message. Other values may be used to indicate the type of message that is being sent and the disclosure of using various binary values to indicate the message type should not be construed as a limitation of the present invention. The L2 trigger data field 42 includes a request indicator 48, a reserved data field 50 and a lifetime data field 52. In the preferred embodiment, the request indicator 48 is set to the binary value of one when the registration message is a registration request message and is set to a binary value of zero when the registration message is a registration acknowledgement message. The reserved field 50 may be used for application specific data.

The lifetime data field 52 is used to indicate the number of seconds remaining or the amount of time left before the registration is considered expired. This field is set to the requested lifetime value by the client 12, 18 and granted a lifetime value by the server 14, 16. In the preferred embodiment, a value of zero sent in the lifetime data field 52 indicates a request for deregistration. In addition, a value of 0xffff is used to indicate a registration that lasts for an infinite amount of time.

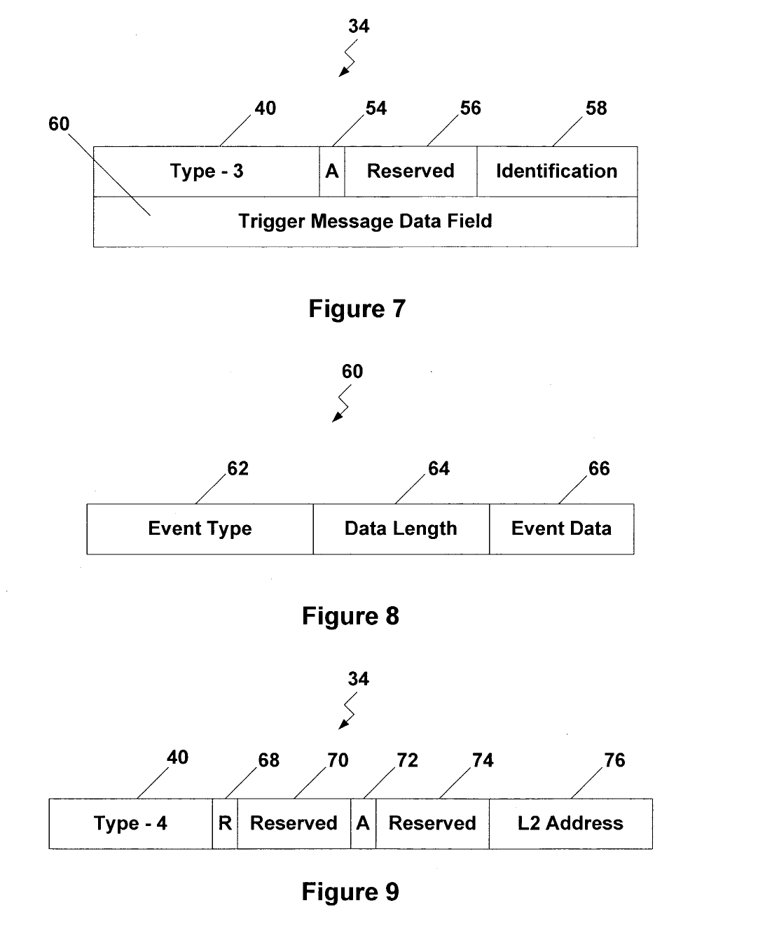

Referring to FIG. 7, the trigger message is used by servers 14, 16 to deliver L2 trigger event notifications to the clients 12, 18. The L2 trigger header 34 includes the following protocol fields for the preferred trigger message. The type field 40 is set to a predetermined value to indicate that the message is a trigger message, which is illustrated as set to the binary value of three in the embodiment illustrated in FIG. 7.

The trigger message includes an acknowledgement field 54 that may simply be represented as a bit that when set, requests the client 12, 18 to send back an acknowledgement of receipt of the trigger message. The client 12, 18 sends back a trigger message with the acknowledgement field 54 set to a predetermined value, a zero in the preferred embodiment, identification copied from the incoming trigger message in the data field or an indication that no data to acknowledge receipt of a trigger message. A reserved field 56 is also included in the L2 trigger data field 42 that may be used for application specific data.

The L2 trigger data field 42 also includes an identification field 58. In the preferred embodiment, the identification field 58 is a 16-bit number, constructed by the server 14, 16, used for matching trigger messages with trigger acknowledgement messages.

The L2 trigger data field 42 also includes a trigger message data field 60 that is used to transmit L2 event specific data to the client 12. The trigger message data field 60 includes an event type field 62, a data length field 64, and an event data field 66. The value of the event type field 62 is used to indicate the type of L2 trigger event that is being experienced by the wireless link that the client 12, 18 is using. In the preferred embodiment, the value of the event type field 62 may be used to indicate (1) a link up; (2) a link down; (3) a source pre-trigger; (4) a target pre-trigger; and (5) a mobile pre-trigger. The data length field 64 is used to indicate the length of the event data field 66.

Event data includes a single L2 address for link up, link down, and mobile trigger events. When the client 12 receives a trigger message that indicates a link up event, an L2 address specified in the event data field 66 indicates the link-layer address of the newly associated access point or server 14, 16. Similarly, when an access router or second client 18 receives a link up trigger, an L2 address specified in the event data field 66 indicates the link-layer address of the newly associated access point 16.

Event data includes two L2 addresses for source trigger and target trigger messages. The first address is the L2 address of an access point 16 and the second address is the L2 address of an access device 14. When an access router 18 receives a source trigger, the first L2 address indicates the anticipated destination access point 16 of an access device 14, which is identified by the second L2 address. Similarly, when an access router 18 receives a target trigger, the first L2 address indicates the source access point 16 of an anticipated access device 14, which is identified by the second L2 address.

Pre-triggers are based on anticipation and not actual L2 events. As such, they might need to be cancelled in case conditions leading to their anticipation change. In this case, the server 14, 16 sends another pre-trigger message and sets the L2 address field of the access point 16 to a value of zero and specifies the access device 14 in the second L2 address field. The client 12 must be able to identify an earlier sent L2 trigger based on the L2 address of the access device 14 and disregard the previous event. Similarly, the L2 address is set to a value of zero to indicate a pre-trigger cancellation for mobile pre-trigger messages.

The L2 addresses may be specified in a variable length field. The content and format of this field (including byte and bit ordering) is expected to be specified in specific documents that describe how IP operates over different link layers. Both access routers 18 and clients 12 can receive link up and link down messages. Only clients 12 can receive mobile pre-trigger messages and only access routers 18 can receive source pre-trigger messages and target pre-trigger messages.

As set forth above, the type field 40 of the L2 trigger header 34 may also be used to indicate that a query message is being sent by the clients 12, 18. This message is used by clients 12, 18 for querying the state of a given link. The L2 trigger header 34 for the query message also includes a request indicator 68, which in the preferred embodiment is set to a value of one when the query message is a query request message and set to a value of zero when the query message is a query response message. A reserved field 70 is also included in the L2 trigger data field 42 that may be used for application specific data.

Referring to FIG. 9, the preferred query message also includes an association indicator 72 that is set to a value of zero when sent in a query request and ignored upon receipt and set to a value of one in a query response message if the queried L2 address is still associated. A second reserved field 74 is also included in the L2 trigger data field 42 that also may be used for application specific data.

The L2 address of the wireless link remote end-point queried by the sender of a query request message. If query request is sent by a client 12, 18, this field contains L2 address of an access point 16. If query request is sent by an access router 18, this field contains L2 address of an access device 14. The query response must copy this field from the incoming query request, set the R bit to 1, and specify the A bit according to the link state. The L2 address is specified in variable length field. The content and format of this field (including byte and bit ordering) is expected to be specified in specific documents that describe how IP operates over different link layers. Link-layer triggers are used in making routing decisions as in wireless access networks 10. As such, their misuse can lead to undesirable side effects and therefore must be prohibited. The time-to-live field of messages are set to 255 and verified by the receivers. Therefore, nodes that are not on the same IP link cannot use this protocol. This provides against unauthorized use of the L2 trigger protocol by off-link nodes.

Protection against unauthorized use by on-link nodes can be accomplished by using IPsec. Hello messages do not have to be secured, but registration, trigger and query messages can be secured by using IPsec. IPsec can provide both authentication and privacy when needed. Required security associations among clients and servers need to be established in advance.

While the invention has been described in its currently best-known modes of operation and embodiments, other modes, embodiments and advantages of the present invention will be apparent to those skilled in the art and are contemplated herein.

What is claimed is:

1. A method for providing trigger notification to a client using a wireless access device to establish a wireless link with an access point, comprising the steps of:
identifying an address of the wireless access device connected with the client;
registering the client with the wireless access device;
generating an L2 trigger datagram with the wireless access device when the wireless access device experiences an L2 trigger event; and
sending the L2 trigger datagram to the client.

2. The method of claim 1, where the L2 trigger datagram includes an L2 trigger type field and an L2 trigger data field

3. The method of claim 1, where the address of the wireless access device is identified by manual configuration.

4. The method of claim 1, where the address of the wireless access device is identified by a dynamic discovery application.

5. The method of claim 1, where the client identifies the wireless access device by sending a multicast hello message to a predetermined IP address and the wireless access devices generates a unicast hello message that is sent back to the client in response to the multicast hello message.

6. The method of claim 1, where the client registers with the wireless access device by sending a registration message to the wireless access device and the wireless access device acknowledges registration by generating a registration acknowledgement message that is sent to the client.

7. The method of claim 1, where the L2 trigger event may be selected from a group of invents including a link down event, a link up event, a source pre-trigger event, a target pre-trigger event, and a mobile pre-trigger event.

8. The method of claim 1, further comprising the step of sending a pre-trigger cancel message to indicate that conditions leading to an earlier sent L2 trigger datagram should be disregarded by the client.

9. The method of claim 1, where the wireless access device is connected with the client with a wired link.

10. An L2 trigger protocol for data communication between nodes in a wireless access network, comprising:
a client connected to a wireless access device, where the client and the wireless access device are operable to communicate with one another using an L2 trigger datagram; and
where the L2 trigger datagram includes an IP header, a UDP header and a L2 trigger header.

11. The L2 trigger protocol of claim 10, where the L2 trigger header includes an L2 message type field for identifying a respective type of L2 message being communicated and an L2 data field for transmitting a data message.

12. The L2 trigger protocol of claim 11, where the type of L2 message may be selected from a group of L2 messages including a hello message, a registration message, a trigger message, and a query message.

13. The L2 trigger protocol of claim 12, where the hello message is used to discover the wireless access device.

14. The L2 trigger protocol of claim 12, where the hello message includes a client indicator that is set to a first predetermined value when the hello message is sent by the client and is set to a second predetermined value when the hello message is not sent by the client.

15. The L2 trigger protocol of claim 12, where the registration message is used to register the client with the wireless access device.

16. The L2 trigger protocol of claim 12, where the registration message includes a request indicator and a lifetime data field.

17. The L2 trigger protocol of claim 16, where the request indicator is set to a first predetermined value when the registration message is a registration request message and is set to a second predetermined value when the registration message is a registration acknowledgement message.

18. The L2 trigger protocol of claim 16, where the lifetime indicator represents an amount of time that the client has remaining to be registered with the wireless access device.

19. The L2 trigger protocol of claim 12, where the trigger message includes an acknowledge request indicator, an identification number, and a trigger data field.

20. The L2 trigger protocol of claim 19, where the acknowledge request indicator is set to a first predetermined value if the client must send back an acknowledgement.

21. The L2 trigger protocol of claim 19, where the identification number is used for matching the trigger messages with a trigger acknowledgment.

22. The L2 trigger protocol of claim 19, where the trigger data field includes a stream of L2 event data.

23. The L2 trigger protocol of claim 22, where the stream of L2 event data includes an event type indication, a data length indication and a trigger event data field.

24. The L2 trigger protocol of claim 23, where the event type indication is used to identify an L2 trigger event that may be selected from a group of L2 trigger events including a link up event, a link down event, a source pre-trigger event, a target pre-trigger event, and a mobile pre-trigger event.

25. The L2 trigger protocol of claim 23, where the data length indication is used to identify a size associated with the trigger event data field.

26. The L2 trigger protocol of claim 23, where the trigger event data field identifies a respective trigger event.

27. A method protocol for data communication, the method protocol comprising the steps of:
generating an L2 trigger datagram with a server, where the L2 trigger datagram is generated using an L2 trigger protocol that includes an IP header, a UDP header and an L2 trigger header; and
transmitting the L2 trigger datagram to a client connected to the server.

28. The method protocol of claim 27, where the L2 trigger header includes an L2 message type field for identifying a respective type of L2 message being communicated and an L2 data field for transmitting a data message.

29. The method protocol of claim 28, where the type of L2 message may be selected from a group of L2 messages including a hello message, a registration message, a trigger message, and a query message.

30. The method protocol of claim 29, where the hello message is used to discover the wireless access device.

31. The method protocol of claim 30, where the hello message includes a client indicator that is set to a first predetermined value when the hello message is sent by the client and is set to a second predetermined value when the hello message is not sent by the client.

32. The method protocol of claim 29, where the registration message is used to register the client with the wireless access device.

33. The method protocol of claim 29, where the registration message includes a request indicator and a lifetime indicator.

34. The method protocol of claim 33, where the request indicator is set to a first predetermined value when the registration message is a registration request message and is set to a second predetermined value when the registration message is a registration acknowledgement message.

35. The method protocol of claim 33, where the lifetime indicator represents an amount of time that the client has remaining to be registered with the wireless access device.

36. The method protocol of claim 29, where the trigger message includes an acknowledge request indicator, an identification number, and a trigger data field.

37. The method protocol of claim 36, where the acknowledge request indicator is set to a first predetermined value if the client must send back an acknowledgement.

38. The method protocol of claim 36, where the identification number is used for matching the trigger messages with a trigger acknowledgment.

39. The method protocol of claim 36, where the trigger data field includes a stream of L2 event data.

40. The method protocol of claim 39, where the stream of L2 event data includes an event type indication, a data length indication and a trigger event data field.

41. The method protocol of claim 40, where the event type indication is used to identify an L2 trigger event that may be selected from a group of L2 trigger events including a link up event, a link down event, a source pre-trigger event, a target pre-trigger event, and a mobile pre-trigger event.

42. The method protocol of claim 40, where the data length indication is used to identify a size associated with the trigger event data field.

43. The method protocol of claim 40, where the trigger event data field identifies a respective trigger event.

44. An L2 trigger notification system for exchanging L2 trigger messages with a client, comprising:
a trigger detection module for detecting an L2 trigger event experienced by a wireless bridge;
an L2 trigger module for generating an L2 trigger datagram when the trigger detection module detects the L2 trigger event, where the L2 trigger datagram includes a L2 trigger header; and
a control module for transmitting the L2 trigger datagram to the client.

45. A client exchanging a link-layer trigger protocol with a wireless access device, comprising:
an identification module for identifying an IP address associated with the access device;
a registration module for registering the client with the wireless access device; and
an L2 trigger module for generating a trigger message that is sent to the client if a predetermined L2 event is experienced by the access device.
